(19) United States
(12) Patent Application Publication
(10) Pub. No.: US 2024/0225801 A1
(43) Pub. Date: Jul. 11, 2024

(54) VALVE ASSEMBLY FOR ORAL IRRIGATORS

(71) Applicant: WATER PIK, INC., Fort Collins, CO (US)

(72) Inventor: Robert D. WAGNER, Fort Collins, CO (US)

(21) Appl. No.: 18/408,179

(22) Filed: Jan. 9, 2024

Related U.S. Application Data
(60) Provisional application No. 63/438,180, filed on Jan. 10, 2023.

(51) Int. Cl. A61C 17/028; F04B 49/24; F04B 53/10

(52) U.S. Cl. CPC A61C 17/028; F04B 49/24; F04B 53/10

(57) ABSTRACT

Various embodiments of oral irrigators are disclosed. In one embodiment, an oral irrigator is disclosed that includes a handle including a tip, a reservoir, a pump assembly fluidly coupled to the reservoir and the tip and configured to pump fluid from the reservoir to the tip and a valve assembly that directs fluid from the pump back to the reservoir when a flow path between the tip and the pump assembly is obstructed, where the valve assembly is vibrationally isolated from the pump assembly.

### CROSS-REFERENCE TO RELATED APPLICATIONS

This application claims priority to U.S. Provisional Patent Application No. 63/438,180 filed on 10 Jan. 2023 titled “Valve Assembly for Oral Irrigators,” which is hereby incorporated by reference herein in its entirety for all purposes.

### TECHNICAL FIELD

The present disclosure relates generally to oral health devices, such as oral irrigators.

### BACKGROUND

Many people use oral irrigators and other electronic oral health devices, such as tooth brushes, to maintain and improve oral health. Many oral irrigators include an electrically driven pump that pumps fluid from a reservoir or other fluid supply to a handle. The pump assembly and drive assembly for operating the pump typically include a motor, a pump and/or gear housing, and various linkages. In some instances, the oral irrigators will include a pause or stop button that allows the user to temporarily stop fluid flow out of the handle. For example, the handle may include a mechanical valve that prevents fluid from exiting out of the tip. In these instances, the pump may continue running while the pause is activated. This can lead to a pressure build up within the pump assembly, which can lead to wear and tear on the pump assembly and generate additional noise.

### SUMMARY

In one example, an oral irrigator is disclosed. The oral irrigator including a handle including a tip, a reservoir, a pump assembly fluidly coupled to the reservoir and the tip and configured to pump fluid from the reservoir to the tip; and a valve assembly that directs fluid from the pump back to the reservoir when a flow path between the tip and the pump is obstructed, where the valve assembly is vibrationally isolated from the pump assembly.

In one example, the valve assembly is fluidly coupled to the pump assembly via one or more flexible connections.

In one example, the valve assembly comprises a valve housing defining a pump connector in fluid communication with an outlet of the pump assembly.

In one example, the pump connector is coupled to the outlet of the pump assembly via a hose.

In another example, the flow between the pump connector and a valve chamber is in a single direction.

In one example, the oral irrigator further comprises a handle valve coupled to the handle and positioned within the flow path to selectively obstruct flow through the flow path to the tip.

In one example, the oral irrigator further comprises a housing enclosing the pump assembly, wherein the valve assembly is rigidly secured to the housing.

In one example, a surface of the valve housing directly engages a surface of the housing.

In another example, a fastener extends through a portion of the valve assembly and a portion of the housing to secure the valve assembly to the housing.

In one example, the valve assembly further comprises a valve body and a relief valve assembly at least partially received within the valve body, wherein the relief valve assembly is movable within the valve body between an open position and a closed position.

In yet another example, the relief valve comprises a relief valve body defining a flow bore therein and flow from the pump assembly flows through the flow bore when the relief valve assembly is in the closed position.

In one example, the flow bore terminates before a first end of the relief valve body.

In one example, in the open position, a bypass flow path is defined within the valve body around an exterior of the relief valve body.

In another example, the first end of the relief valve body is closed.

In yet another example the valve assembly comprises a one-way valve, where the one way valve closes due to the flow path being obstructed.

In another example, a valve assembly for an oral irrigator is disclosed. The valve assembly may include a valve housing defining a valve chamber, the valve chamber in fluid communication with a pump assembly and a reservoir and a relief valve assembly received within the valve housing and movable between a first position and a second position within the valve housing. The relief valve assembly may include a relief valve body having a closed end and an open end, a seal coupled to the closed end of the relief valve body, and a one-way valve positioned adjacent to the open end of the relief valve body, where in a first position the seal engages a sidewall of the valve housing to prevent fluid flow from the valve chamber to the reservoir and the one-way valve opens to allow fluid flow to exit the valve chamber from the open end of the valve body and in a second position the one-way valve closes the seal disengages the sidewall of the valve housing to enable fluid flow from the valve chamber to the reservoir.

In one example, the open end of the relief valve is in fluid communication with a handle flow path and the one-way valve closes upon a blockage of the handle flow path.

In one example, the relief valve body comprises one or more valve ports defined therein, wherein in the first position, fluid flows into the valve ports through the open end of the relief valve.

In another example, the valve assemble in the second position, a bypass flow path is defined between an exterior of the relief valve body and the sidewall of the valve housing.

In yet another example, the valve housing is configured to be rigidly mounted to a housing of an oral irrigator.

In one example, the valve housing comprises a pump connector in fluid communication with the pump assembly and the valve chamber, wherein the pump connector delivers fluid to the valve chamber from the pump assembly.

In one example, the fluid flow through the pump connector flows in a single direction, from the pump assembly to the valve chamber.

In another example, the fluid connection between the pump connector and the pump assembly is configured to substantially prevent vibrations from being transmitted to the valve assembly.

In another example, the relief valve body further defines a valve bore in fluid communication with the valve chamber and the open end of the relief valve body.

In one example, the valve bore extends partially along a length of the relief valve body.

In yet another example, an interior wall of the relief valve body defines a first end of the valve bore and the open end of the relief valve body defines a second end of the valve bore.

In one example, the valve housing comprises; a reservoir port configured to fluidly couple to a reservoir, and a pump connector configured to fluidly couple to a pump assembly.

In yet another example, an oral irrigator is disclosed. The oral irrigator includes a handle including a tip, a reservoir, a pump assembly fluidly coupled to the reservoir and the tip and configured to pump fluid from the reservoir to the tip, and a valve assembly that directs fluid from the pump back to the reservoir when a flow path between the tip and the pump assembly is obstructed. The valve assembly includes a valve housing defining a valve chamber, a relief valve assembly movable within the valve chamber between a first position defining a first flow path to the tip and a second position defining a second flow path to the reservoir, and a pump connector coupled to the valve housing in fluid communication with the pump assembly and the valve chamber, where the fluid flows in a single direction through the pump connector.

In one example, the pump connector receives fluid from the pump assembly and delivers the fluid to the valve chamber.

In one example, the pump connector is in fluid communication with a pump outlet of the pump assembly.

In another example, the oral irrigator further comprises a flexible fluid connector that extends between the pump assembly and the pump connector to fluidly couple the pump connector to the pump assembly.

In one example, the flexible fluid connector limits vibration transmission between the pump assembly and the valve assembly.

In one example, the oral irrigator further comprises a housing enclosing the pump assembly and the valve assembly, wherein the valve assembly is rigidly coupled directly to a surface of the housing.

In another example, in the first position, the relief valve assembly seals a flow path between the reservoir and the valve chamber and in a second position the relief valve assembly opens the flow path between the reservoir and the valve chamber.

In yet another example, when the flow path to the tip is blocked the relief valve assembly remains in the second position.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claims or their applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the oral irrigator and/or valve assembly described herein and should not be construed as a complete depiction of the scope of the claimed features.

FIG. 1 is an isometric view of an oral irrigator including a valve assembly.

FIG. 2A is a top isometric view of the valve assembly of FIG. 1.

FIG. 2B is a bottom isometric view of the valve assembly of FIG. 1.

FIG. 3 is an exploded view of the valve assembly of FIG. 1.

FIG. 4A is a front isometric view of a pressure relief valve of the valve assembly of FIG. 1.

FIG. 4B is a cross-section view of the pressure relief valve of FIG. 4A taken along line 4B-4B in FIG. 4A.

FIG. 5A is a top plan view of a spring retainer for the valve assembly of FIG. 1.

FIG. 5B is a bottom plan view of the spring retainer of FIG. 5A.

FIG. 6A is a cross-section view of the valve assembly taken along line 6-6 in FIG. 2A illustrating a pressure relief valve in a first configuration.

FIG. 6B is a cross-section view of the valve assembly taken along line 6-6 in FIG. 2A illustrating the pressure relief valve in a second configuration.

Embodiments of this disclosure and their advantages are best understood by referring to the detailed description that follows. It should be appreciated that like reference numerals are used to identify like elements illustrated in one or more of the figures.

### DETAILED DESCRIPTION

Embodiments of the present disclosure relate to components of an oral irrigator that may include improved configurations for a valve assembly that may be used in conjunction with one or more pump assemblies, pump housings, and/or drive assemblies, all of which may be used together (as shown in various figures) or may be used separately from one another depending on the type of oral irrigator (e.g., countertop versus handheld), spacing/sizing, and the like. Similarly, the discussion of particular features of the valve assembly may be used in conjunction with other components or features of the valve assembly or separately therefrom. As such, the discussion of any particular element, feature, component, assembly, or the like, should be understood as being a standalone element, or may be integrated into a system. Relatedly, although the discussion presented herein is related to oral irrigators, the concepts and embodiments may be applicable to other types of oral health devices, such as, but not limited to, brushing devices, combination irrigating brushing devices, or other elements that may pump fluid from one location, such as a reservoir, to another.

In one embodiment, a valve assembly is disclosed that may be used to enable bypass flow of fluid when flow through an outlet is obstructed, e.g. when flow is obstructed to the tip, such as when a handle pause or stop button is actuated. When actuated, the valve assembly may continuously direct fluid from the pump back to the reservoir without the valve assembly needing to cycle or open/close multiple times. Due to the bypass flow, the pump can continue to operate, without generating substantial back pressure or increasing the load on the pump as compared to normal operating conditions. This allows a user to pause or stop the flow via the handle for an extended length of time without excessive noise and without generating excess load and possible wear on the pump assembly. In this manner, a user can stop the flow without having to access (for example) an electronic control that may be on a base portion of the oral irrigator and/or without requiring electronic components, such as wires, to have to extend from the handle to the base or housing.

The valve assembly may include a pressure relive valve assembly that includes a relief valve and a one-way valve, where the relief valve may be actuated by fluid pressure buildup when the one-way valve closes and fluid continues to flow into the valve assembly via the pump assembly. The relief valve then opens to enable fluid flow through a bypass or return flow path back to the reservoir, reducing fluid pressure build up within a valve housing and/or in the pump assembly.

The valve assembly may be fluidly, but indirectly connected to the pump assembly, such as via one or more flexible connections (e.g. hose or tubes), helping to reduce vibration transmission from the pumping assembly to the valve assembly, which can overall reduce noise and movement that can generate wear on different components. Further, the separation of the valve assembly from pump assembly (e.g., the pump assembly may not be formed on the same part as the valve housing), may allow additional components, such as one or more check valves and/or pump inlets to be connected to or defined in other components, helping to reduce the size or strength of various seals within the valve assembly as the seals may not have to seal around flow ports or the like. In this manner, other components, such as springs or actuators, may be able to be smaller (e.g. require less biasing force), which helps to reduce overall strain on various components of the valve assembly.

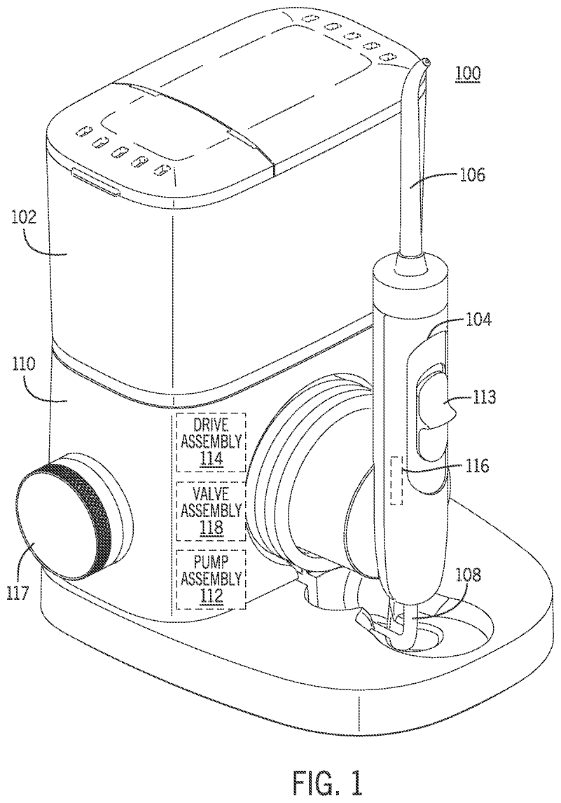

FIG. 1 illustrates an oral irrigator including a valve assembly as described herein. The oral irrigator 100 may include a reservoir 102 that holds a fluid, such as water or mouthwash, to provide the fluid to a pump. In instances where the oral irrigator 100 is a countertop unit, the reservoir 102 may be coupled to a housing 110 or base and where the oral irrigator 100 is a handheld unit the reservoir 102 may be coupled to a handle 104 or hand piece for the oral irrigator 100. Relatedly, the size and volume capacity of the reservoir 102 may be based on the type and configuration of the oral irrigator 100. The reservoir 102 may include a reservoir outlet, such as a port or plug, valve, or the like, that is fluidly coupled to other components of the oral irrigator 100 (e.g., a pump assembly or valve assembly).

With continued reference to FIG. 1, oral irrigator 100 may include a housing 110 or base, which in the embodiment illustrated in FIG. 1 acts to support the oral irrigator 100 on a surface (e.g., countertop) and optionally may support the reservoir 102. In some instances, the housing 110 may be configured as a countertop support, but in other iterations may be formed as a handle or a portion held in the hand of a user during use. The housing 110 supports and/or encloses one or more components of the oral irrigator 100, such as a pump assembly 112 and/or drive assembly 114. Additionally, the housing 110 may include fluid pathways (e.g., tubes, hoses) that direct fluid between different components of the oral irrigator, such as between the reservoir 102 and the pump assembly 112 and/or drive assembly 114 and an outlet, such as a handle.

A handle 104 may be fluidly coupled to the reservoir 102, such as via a hose 108 or other fluid connector. The handle 104 may include a tip 106 or other outlet device that can direct fluid from the reservoir 102 into a user's oral cavity. The handle 104 may be configured to be held in a user's hand and in embodiments where the oral irrigator 100 is configured as a handheld device, may include features of the housing 110, e.g., the pump assembly 112 and/or drive assembly 114 may be coupled to or positioned within the handle 104. The handle 104 may also include features to secure the tip 106 thereto and optionally allow release of the tip 106 therefrom. The tip 106 may be in the form of a jet tip or other tip configuration, e.g., may include bristles (e.g., nozzle integrated with a brush head), tongue scraper, or the like.

In many implementations, the handle 104 may include a handle valve 116 that allows selective closing of a fluid pathway from the hose 108 to the tip 106. The handle valve 116 may be coupled to a handle control 113, such as a button or switch that allows a user to stop flow out of the tip 106. The handle valve 116 may be positioned within a flow pathway between the hose 108 and the tip 106, such as a handle flow path, and may seal, block, or otherwise prevent flow past the handle valve 116 when activated. In many embodiments, the handle valve 116 may be a mechanical valve and/or may not be in electrical communication with the drive assembly 114 or pump assembly 112, such that when the handle valve 116 is activated, the pump assembly 112 may continue to pump fluid from the reservoir 102, but the fluid is blocked either within the handle 104 or another location along the flow pathway from exiting the tip 106. The mechanical configuration helps to allow the handle 104 to be free from electrical connections (e.g. wires) that would need to extend from the handle 104 to the base or housing 110, but still allow a user to stop fluid flow out of the handle 104.

The pump assembly 112 may include various pump components that assist in pumping and directing fluid from the reservoir 102 into the handle 104 and tip 106. For example, the pump assembly 112 may include a pump body, a piston, a connecting rod, and one or more valves. An example of a pump assembly may be found in U.S. Pat. No. 8,888,727 titled Vibration Damping for Dental Water Jet, incorporated herein for all purposes. Similarly, the drive assembly 114 may be operably coupled to the pump assembly 112 and may be configured to include one or more drive elements (e.g., motor, linkages, gears, gear supports, etc.). The drive assembly 114 assists in driving or actuating the pump assembly 112 or components thereof and will be discussed in detail below. Examples of the drive assembly may also be found in the '727 patent mentioned above.

With continued reference to FIG. 1, the oral irrigator 100 may include a flow adjuster 117, which may be in the form of a button, switch, or as shown in FIG. 1, a knob. The flow adjuster 117 may be coupled to and/or form a part of a flow adjustment assembly that reduces a flow volume delivered to the hose 108 and/or handle 104, which may help to reduce a pressure experienced by the user when operating the oral irrigator 100. For example, the user may turn the flow adjuster 117 to increase or decrease the flow and correspondingly to increase or decrease the pressure.

A valve assembly 118 may be fluidly coupled to the pump assembly 112. The valve assembly 118 may be positioned within the housing 110 and in some embodiments may be rigidly coupled to the housing 110. The valve assembly 118 may also be directly coupled to a surface of the housing 110, such that one or more surfaces of the valve assembly 118 may engage directly a surface of the housing 110. The valve assembly 118 receives fluid from the pump assembly 112 and is fluidly connected to both the reservoir 102 and the handle 104 via the hose 108.

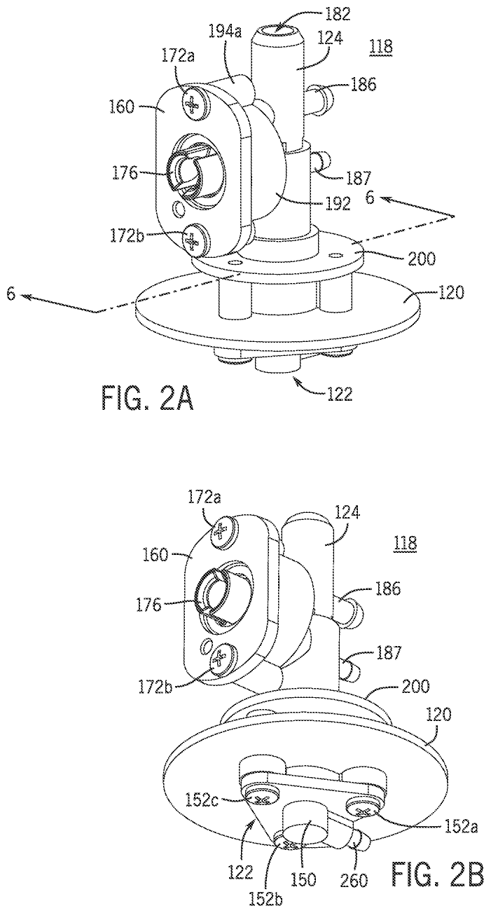

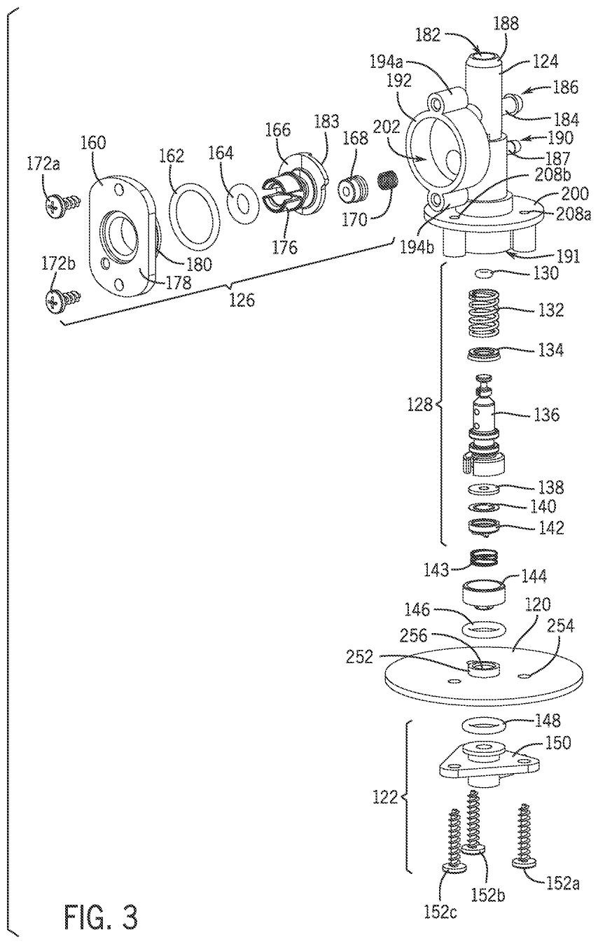

FIGS. 2A-3 illustrate various views of the valve assembly 118. With reference to FIGS. 2A-3, the valve assembly 118 may include a flow adjustment assembly 126 that couples to the flow adjuster 117 to receive a user input to the flow adjustment assembly 126. The flow adjustment assembly 126 may be similar to the pressure adjustment assembly disclosed in U.S. Publication No. 2022/0023019 titled “Bypass flow assembly of an oral irrigator,” which is incorporated by reference herein for all purposes. With reference to FIG. 3, the flow adjustment assembly 126 or pressure adjustment assembly may include a valve retainer 160 that includes a front surface 178 including apertures defined therein and a flange 180 extending from the rear side.

The flow adjustment assembly 126 may also include a plurality of seals, such as seal 162, seal 164, and seal 168. The seals 162, 164, 168 may be defined as O-rings, U-cups, or the like, and may have varying diameters, thickness, and configurations depending on the components that the seals 162, 164, 168 may be configured to seal against to prevent fluid from leaking between components.

A flow adjustment valve 166 may also be included as part of the flow adjustment assembly 126. The flow adjustment valve 166 may include an engagement feature 176, such as flexible arms that extend from a first side of the valve 166 and are configured to engage with flow adjuster 117, e.g. the flow adjuster 117 couples to the flow adjustment valve 166 such that movement of the adjuster 117 will move the flow adjustment valve 166. The flow adjustment valve 166 may define a flow pathway 183 of varying width and/or depth on the back side thereof. In this manner, a position of the flow adjustment valve 166 relative to an inlet or outlet may vary a flow volume between the inlet and outlet. A spring 170 may act to bias the seal 168 towards the adjustment valve 166.

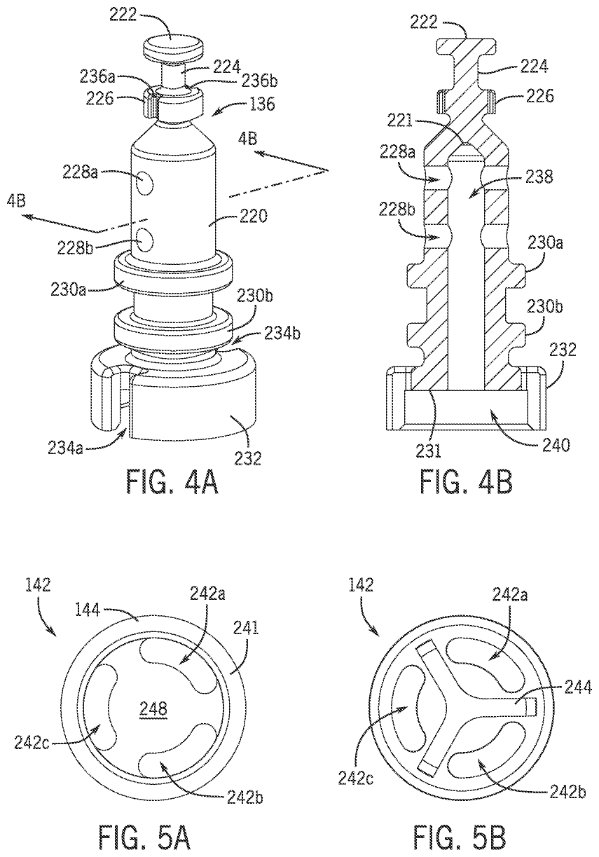

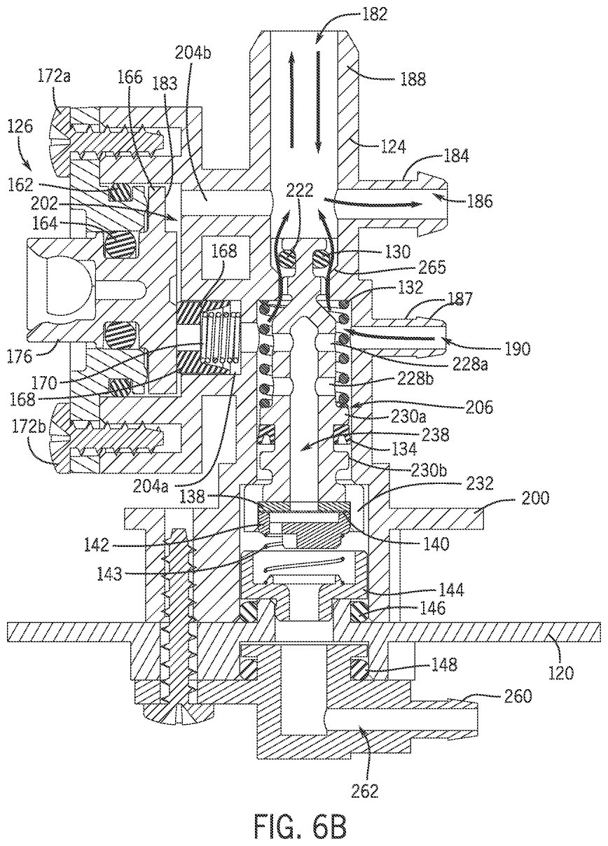

FIG. 6A illustrates a cross-section view of the valve assembly 118. With reference to FIGS. 3 and 4A, the valve assembly 118 may further include a valve housing 124. The valve housing 124 may be coupled to the housing 110 and fluidly coupled to the pump assembly 112, reservoir 102, and handle 104. The valve housing 124 may include a wall 192 defining a flow adjustment compartment 202. The flow adjustment compartment 202 includes a fluid inlet 204a and a fluid outlet 204b (see FIG. 6A), both of which are fluidly coupled to a valve bore 182 extending through the valve housing 124. Two or more fastener posts 194a, 194b may be coupled to the wall 192 or otherwise extend from the valve housing 124 and be configured to receive one or more fasteners.

With reference to FIGS. 3 and 4, the valve bore 182 may extend through the length of the valve housing 124 and define a valve inlet or a reservoir port 188 on a first end and a valve outlet 191 on a second end and a valve chamber 206 therebetween. The valve bore 182 or valve flow pathway may be fluidly coupled to a pump inlet 186 and a pump outlet 190, which may be formed by one or more pump connectors 184, 187, which may be defined as barbs that extend outwards from the valve housing 124. The pump connectors 184, 187 may be configured to couple to the pump assembly 112, such as to an inlet and outlet of the pump assembly 112. In some configurations the pump connectors 184, 187 may be rigidly coupled to the pump assembly 112 (e.g. directly mounted to a pump body), but in other configurations, such as the one shown in FIGS. 2A-4A, the pump connectors 184, 187 may be configured to flexibly couple to the pump assembly 112, such as via tubing or hoses or otherwise may be separated from the pump assembly 112 to limit vibration transmission therebetween. The pump connector 184 may define a pump inlet 186 and the pump connector 187 may define or be coupled to a pump outlet 190.

In some embodiments, one or both of the pump connectors 184, 187 may be configured as unidirectional ports or connectors. For example, the pump connector 187 may be configured to transmit fluid from the pump assembly 112 (e.g. from an outlet of the pump) into the valve chamber 206 and may not transmit fluid into the pump assembly 112 from the valve chamber 206. By including single directional flow paths to and from the pump assembly 112, the valve assembly 118 can be smaller, require fewer parts, e.g. pump valves, such as check valves, may not need to be included in the valve assembly.

It should be noted that although the pump inlet 186 and pump connector 184 are disclosed as being formed with the valve housing 124, in other configurations, the pump inlet 186 and/or the pump connector 184 may be formed in other components and may not be coupled to or fluidly connected to the valve housing 124.

The valve housing 124 may include a valve bore or valve chamber 206 fluidly connected to and forming a portion of the valve bore 182. The valve chamber or valve chamber 206 is configured to receive one or more valves and is fluidly connected to the valve inlet 184 and the valve outlet 194, as well as the pump inlet 186 and pump outlet 190.

A valve base 200 may be coupled to or extend from a bottom end of the valve housing 124. The valve base 200 may include one or more fastening apertures 208a, 208b, 208c. The valve base 200 may define in part the valve outlet 191 and be configured to couple the valve housing 124 to the housing 110 or other coupling surface.

With reference to FIG. 3, a pressure relief assembly 128 may be positioned within the valve housing 124. The pressure relief assembly 128 is configured to selectively open a fluid pathway between the valve bore or valve chamber 206 and the reservoir port 188 to allow flow to the reservoir 102, such as when the valve bore or valve chamber 206 begins to experience a fluid pressure buildup.

The valve assembly 118 and/or pressure relief assembly 128 may include one or more seals 130, 134, 146, which may take the form of O-rings, U-cups, or other compressible elements, that can seal connections or interfaces between various members of the valve assembly 118. It should be noted that although certain configurations of seals are shown (e.g. seal 130 is depicted as an O-ring and seal 134 is depicted as a U-cup), these configurations are meant as illustrative only and other configurations are envisioned, e.g., seal 130 may be a U-cup and seal 134 may be formed as an O-ring.

With continued reference to FIG. 3, the pressure relief assembly 128 may also include one or more springs 132, 143, which may be in the form of a coil spring, but could take on other configurations, and are configured to exert a spring or biasing force against components of the pressure relief assembly 128. For example, the first spring 132 may be configured to exert a force on a relief valve 136 and the second spring 141 may be configured to exert a force on a spring retainer 144.

An optional seal washer 138 may be included with the pressure relief assembly 128 to help secure a one-way valve 140 in position. For example, in instances where the one-way valve 140 is a lighter weight valve (e.g., flexible plastic), the seal washer 138 may apply pressure to a portion of the one-way valve 140, such as around its perimeter, to hold it in position and ensure a better seal. However, in other instances, such as when the one-way valve 140 is made of heavier materials (e.g., metal) or otherwise differently configured (e.g. bonded to the relief valve 136) the seal washer 138 may be omitted.

The one-way valve 140 is configured to allow fluid flow in a single direction. For example, the one-way valve 140 may close or resist fluid pressure in one direction, but open or give way to fluid pressure in a second direction. In one example, the one-way valve 140 is a reed valve, but in other embodiments can be a duckbill valve, spring actuated valve, or the like.

A relief valve 136 may also be included in the pressure relief assembly 128. FIGS. 4A and 4B illustrate various views of the relief valve 136. The relief valve 136 may be formed generally as an elongated member including top and bottom ends. A relief valve body 220 may extend between a head 222 or first end and a base 232 or second end, where the relief valve body 220 includes one or more valve ports 228a, 228b. The valve ports 228a, 228b may extend through both walls of the relief valve body 220, e.g., through a width of the relief valve 136 or may extend through only one wall of the relief valve body 220. A flow or valve bore 238 may be defined within the relief valve body 220 and may extend longitudinally along a length of the relief valve body 220. The flow bore 238 may be in fluid communication with the valve ports 228a, 228b such that fluid can flow into and out of the flow bore 238 via the valve ports 228a, 228b. It should be noted that the flow bore 238 may terminate before reaching the top end of the relief valve body 220. For example, the flow bore 238 may extend through the relief valve body 220 from the base 232 upwards but end before reaching the securing lip 226, neck 224, or head 222. In other words, a top or first end of the relief valve body 220 may be closed or sealed from the flow bore 238. In one example, an interior wall 221 of the relief valve body 220 may close the flow bore 238 adjacent to or at the first end of the relief valve body 220.

The head 222 may form a top end of the relief valve 136 and may also help to secure one or more seals onto the relief valve 136. For example, the head 222 may extend from the relief valve body 220 via a neck 224, which may be configured to receive a seal therebetween (e.g., seal 130). In embodiments where the flow bore 238 is sealed on the top end of the relief valve body 220 (as shown in FIG. 4B), the neck 224 may have a decreased diameter as compared to other areas of the relief valve 136, as no fluid will flow therethrough. This may allow the seal 130 to have a reduced diameter as compared to implementations where flow may extend through the entire length of the relief valve 136, which can in turn reduce the spring force required to unseat the seal 130 as discussed in more detail below.

A securing lip 226 may be spaced below and apart from the head 222, e.g. the neck 224 may extend between the securing lip 226 and the head 222. The securing lip 226 may include one or more notches 236a, 236b to improve the flow when the valve is open. However, in other implementations the notches 236a, 236b may be omitted.

One or more sealing flanges or lips 230a, 230b may be formed on a bottom end of the relief valve body 220. For example, the sealing lips 230a, 230b may be formed on the relief valve body 220 below the ports 228a, 228b and be configured to secure one or more seals that may be positioned around the relief valve body 220. A bottom end of the relief valve body 220 may include the base 232, which may define a chamber 240 on an interior thereof. The chamber 240 may form an outlet port for the relief valve 136.

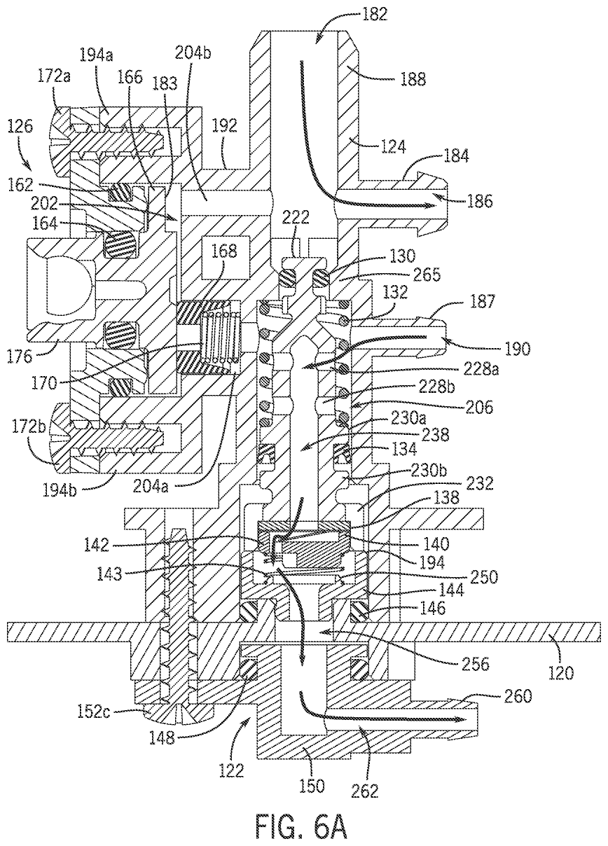

A valve retainer 142 may form a portion of the relief valve assembly 128. FIGS. 5A and 5B illustrate top and bottom plan views of the valve retainer 142. With reference to FIGS. 5A and 5B, the valve retainer 142 may include a rim 241 that defines an upper chamber. One or more fluid ports 242a, 242b, 242c may be formed on a bottom surface 248 of the chamber. In the example shown in FIGS. 5A and 5B, the fluid ports 242a, 242b, 242c may be curved slots that may be arranged around a perimeter of the bottom surface 248. However, in other embodiments the fluid ports 242a, 242b, 242c may be differently configured and/or the valve retainer 142 may include a single fluid port or more fluid ports than are shown in FIGS. 5A and 5B. With reference to FIG. 5B, one or more ribs 244 or feet may extend from the bottom surface 248 in a direction opposite the rim 241. In one example, the ribs 244 may be interconnected and form a Y pattern, such that each of the fluid ports 242a, 242b, 242c may be positioned between two ribs 244. However, in other examples, the ribs 244 may be disconnected from one another or the valve retainer 142 may include a single rib.

With reference again to FIG. 3, the valve assembly 118 may further include a seal and/or spring retainer 144 that may be configured to secure a seal 146 and/or a spring. For example, the spring retainer 144 may include a lip 250 (see FIG. 6A) on a bottom surface to receive one or more coils of a spring (e.g., spring 143). Additionally or alternatively, the seal or spring retainer 144 may be configured to retain seal 146 in position relative to the valve assembly 118 (see FIG. 6A).

With continued reference to FIG. 3, the valve assembly 118 may be configured to couple to a mounting surface 120. In one example, the mounting surface 120 may be formed with or coupled to the housing 110 of the oral irrigator 100. For example, the mounting surface 120 may be a portion of a bottom wall or surface of the housing 110 or base. In other examples, the mounting surface 120 may be positioned within and coupled (either directly or indirectly) to the housing 110. The mounting surface 120 may include a reception lip 252 that may act to receive a portion of the spring retainer 144 or a component of the relief valve assembly 128. The reception lip 252 may also extend from a bottom of the mounting surface 120 to couple to or receive portions of the fitting assembly 122.

A mounting outlet 256 may be formed in the mounting surface 120 and may be fluidly connected to the valve assembly 118 and the pump assembly 112. The mounting outlet 256 may be in fluid communication with the hose 108 or other component coupled to the handle 104 to allow fluid communication from the irrigator 100 to the handle 104. In some embodiments, the mounting surface 120 may also include one or more securing apertures 254 that may be configured to receive fasteners to secure components to the mounting surface 120.

With reference to FIG. 2A, 2B, 3 and 6A, the fitting assembly 122 may be configured to couple to the housing 110 or mounting surface 120 and fluidly couple the hose 108 to the pump assembly 112 and valve assembly 118. The fitting assembly 122 may include a fitting 150 that may define a fitting flow pathway 262 therethrough. The fitting 150 may also include a barb 260 or other connector configured to couple to the hose 108 or other fluid connector for the handle 104. A seal 148 may be configured to be positioned around a top end of the fitting 150 to seal the engagement of the fitting 150 against the mounting surface 120. One or more fasteners 152a, 152b, 152c may be included to help enable a secure coupling of the fitting assembly 122 to the mounting surface 120.

FIG. 6A illustrates a cross-section view of the valve assembly 118 taken along line 6-6 in FIG. 2A. With reference to FIGS. 2A, 3, and 6A, coupling of the valve assembly 118 will be discussed in more detail. It should be noted that while the discussion of the valve assembly 118 below may be discussed in a particular order, this is meant as illustrative only and the actual order of assembly may be varied from the below description.

The flow adjustment assembly 126 may be coupled together such that the spring 170 is positioned in the flow adjustment compartment 202, such as within a cavity defined therein. The seal 168 may be coupled to the spring 170, such as positioned over a top end of the spring 170. The flow adjustment valve 166 may then be positioned over the seal 168 and positioned within the flow adjustment compartment 202 such that the back surface and flow pathway 183 are aligned with the fluid inlet 204a of the flow adjustment compartment 202. Seal 164 may be received around a portion of the flow adjustment valve 166 and seal 162 may be positioned around a portion of the valve retainer 160. The valve retainer 160 may be coupled to the flow adjustment valve 166, such as being received over a portion of the engagement feature 176, where the engagement feature 176 may extend through the valve retainer 160, such as via an aperture. In this manner, the flow adjuster 117 may be able to connect to the flow adjustment valve 166 and be able to move the flow adjustment valve 166. The fasteners 172a, 172b may secure the valve retainer 160 to the valve housing 124, such as being received within the fastener posts 194a, 194b.

With reference to FIGS. 3, 4A, and 6A, assembly of the pressure relief assembly 128 will be discussed. The seal 130 may be positioned on the relief valve 136, for example, may be received around the neck 224 and secured in place by the head 222 and the securing lip 226. The valve body 136 may be coupled to the spring 132, for example, the spring 132 may be received around a portion of the valve body 136. Seal 134 may be coupled to the valve body 136, such as being received between the lips 230a, 230b. The seal washer 138 may be positioned within the base 232 of the valve body 136, such as within the chamber 240 and configured to abut against a top wall 231 of the chamber 240. The one-way valve 140 may be positioned against or adjacent to the seal washer 138 and the valve retainer 142 may be positioned adjacent to and engage against the one-way valve 140 to help secure the one-way valve 140 and the seal washer 138 in position.

With reference to FIG. 6A, the pressure relief assembly 128 may then be positioned within the valve body 124. For example, the pressure relief assembly 128 may be received within the valve chamber 240 and include a least a portion of the pressure relief assembly 128 between the reservoir port 188 and the pump connector 187. Spring 143 may be positioned to engage the valve retainer 142 and spring retainer 144 may be inserted into the valve housing 124 below the pressure relief assembly 128 to retain the spring 143 in position. In this manner, the spring 143 may exert a biasing force against the one-way valve 140, valve retainer 142 and the pressure relief assembly 128 as a whole to help ensure a sealed connection between the one-way valve 140 and the relief valve body 220. In other embodiments, the one-way valve 140 may be secured to the base 232 of the body 220 of the valve 136, which may eliminate the need for spring 143 and valve retainer 142.

Seal 146 may be positioned around the reception lip 252 of the mounting surface 120 and the spring retainer 144 may be coupled to the mounting surface 120, such as being positioned at least partially within the reception lip 252 and in fluid communication with the outlet 256. The seal 146 may be held in position by the spring retainer 144.

With reference to FIGS. 3 and 6A, the fitting assembly 122 may be coupled to the valve assembly 118. For example, the fitting assembly 122 may be coupled to the mounting surface 120 and be positioned to be in fluid communication with the mounting outlet 256. For example, the seal 148 may be positioned around a flange on the fitting 150 and the fitting 150 may engage a bottom of the mounting surface 120 with the fasteners 152a, 152b, 152c coupling to fastening apertures 254 in the mounting surface 120. The fasteners 152a, 152b, 152c may also act to couple the valve housing 124 to the mounting surface 120. For example, the fasteners 152a, 152b, 152 may be received within the fastening apertures 208a, 208b, 208c formed in the valve base 200 and extend through the mounting surface 120 to the valve housing 124. In this manner, the valve assembly 118 may be rigidly coupled to the mounting surface 120 (which may form a portion of the housing 110). The rigid connection via the fasteners 152a, 152b, 152c may be less expensive than other types of connections, such as indirect connections, that may require dampening members or the like positioned between the valve assembly 118 and the mounting surface 120. In some embodiments, the valve assembly 118 may be connected to the mounting surface 120 directly, such that a surface of the valve housing 124 abuts against the mounting surface 120. For example, due to the vibration isolation between the valve assembly 118 and the pump assembly 112, the valve assembly 118 can be mounted without isolators or other dampening elements positioned between the valve assembly 118 and the mounting surface 120 or housing 110. However, in other embodiments, different coupling arrangements may be used.

As noted, in instances where the mounting surface 120 forms a portion of the housing 110, such as a bottom wall of the housing 110, coupling the valve assembly 118 to the mounting surface 120 acts to couple the valve assembly 118 to the oral irrigator 100 and housing 110. However, in other embodiments, the mounting surface 120 may be separately coupled to the housing 110 to couple the valve assembly 118 to the housing 110.

The valve assembly 118 may then be coupled to the reservoir 102, as well as the pump assembly 112. For example, the reservoir port 188 may be fluidly coupled to the reservoir 102, such as via a valve, tube, or other connection (e.g., the reservoir port 188 may be positioned within an aperture or other connector for the reservoir 102). Similarly, the pump inlet 186 and pump outlet 190 may be coupled to the pump assembly 112. For example, one or more tubes or hoses or other flexible fluid pathways may be coupled to the pump connectors 184, 187 to allow fluid communication to and from the pump and the pump inlet 186 and pump outlet 190. Because the connection to the pump assembly 112 may be flexible and/or indirect, e.g., rubber hoses, vibration and other forces from the pump assembly 112 (such as generated due to movement of the piston) may not be transmitted or may be substantially dampened before reaching the valve housing 124. This allows the valve housing 124 to not substantially transmit forces, such as vibrations, to the housing 110.

Operation of the oral irrigator 100 and specifically the valve assembly 118 will now be discussed in more detail. With reference briefly to FIG. 1, to activate the oral irrigator 100, the user may provide an input to the irrigator 100 (such as through one or more control buttons) that acts to operate the drive assembly 114. As the drive assembly 114 turns on, the drive assembly 114 drives the pump assembly 112, for example, a drive shaft may engage one or more gears to drive a connecting arm coupled to a piston to move the piston within a pump chamber.

With reference to FIG. 6A, which illustrates the pressure relief assembly 118 and the flow adjustment assembly 126 in a closed configuration. In this configuration, if the pump is a reciprocating pump, upon a vacuum stroke, the pump assembly 112 generates a vacuum, which pulls fluid from the reservoir 102 into the pump inlet 186. The pump inlet 186 then delivers fluid to the pump chamber (not shown) and upon a compression stroke, the piston forces the fluid to the outlet of the pump assembly 112 and into the pump outlet 190 of the valve assembly 118. It should be noted that in instances where the pump is a reciprocating pump, the pump assembly 112 may include a valve that closes a flow pathway from the pump assembly to the pump inlet 186 during a compression stroke.

Once the fluid is delivered to the pump outlet 190, the fluid flows (designated by the thicker arrows in FIG. 6A), through the pump outlet 190 into the valve chamber 206 of the valve housing 124. Because the pressure relief valve is in the closed position, the seal 130 engages against an interior shoulder 265 within the valve housing 124. The seal 130 prevents or closes a fluid pathway from the valve chamber 206 into the reservoir port 188. It should be noted that in embodiments where the top end of the relief valve body 220 is closed, the spring force required to maintain the engagement of the seal 130 may be reduced as the diameter of the seal 130 may be smaller (e.g., correspond to diameter of the neck portion of the relief valve body 220 rather than a larger diameter, such as of the remaining portion of the relief valve body 220). The smaller diameter requires less spring force as compared to a larger diameter seal.

As fluid is blocked from traveling to the reservoir port 188, the fluid then flows around the pressure relief assembly 128 and through the spring 132 (e.g. between coils of the spring 132) and into the flow bore 238 of the relief valve body 220. For example, the fluid can enter via the ports 228a, 228b formed on either side of the relief valve body 220. In some embodiments, seal 134 of the pressure relief assembly 128 engages against an interior wall of the valve housing 124, limiting fluid from exiting the valve chamber 206 around the exterior of the relief valve body 220, e.g. the fluid in the valve chamber 206 enters the flow bore 238 to exit the pressure relief assembly 128

With continued reference to FIG. 6A, as the fluid flows into the flow bore 238 it is directed downwards toward the one-way valve 140. The one-way valve 140 opens, allowing fluid to flow and exit through the base 232 of the relief valve body 220. It should be noted that with a reciprocating pump, the one-way valve 140 may open and close based on the cycle of the pump (e.g. compression vs. vacuum stroke). However, in instances where the pump is a constant pump, the one-way valve 140 may remain open during operation of the pump assuming the pressure relief valve is in the configuration shown in FIG. 6A.

After exiting the one-way valve 140, the fluid then flows into bottom surface 248 of the chamber of the valve retainer 142 and through fluid ports 242a, 242b, 242c. The fluid can then enter into the spring retainer 144 and out the flow aperture within the spring retainer 144 and into the mounting outlet 256 of the mounting surface 120. From the mounting outlet 256 the fluid can flow to the fitting assembly 122, e.g. enter fluid pathway 262 and flow to the hose 108 and then the handle 104 to be delivered to the tip 106.

In this configuration, the spring 132 exerts a biasing force against the top lip 230a of the relief valve body 220. This allows the base 232 of the relief valve body 220 to abut against the top of the spring retainer 144, transferring a load from the pressure relief assembly 128 to the mounting surface 120 via the spring retainer 144

With continued reference to FIG. 6A, in the event that the user manipulates the flow adjuster 117, the flow adjustment assembly 126 may change from the closed position as shown in FIG. 6A to an open position to allow flow. In the open position, flow is diverted from the valve chamber 206 within the valve housing 124 into the fluid inlet 204a and into the flow adjustment assembly 126 and can return via the fluid outlet 204b and return to the reservoir 102. The flow diversion helps to reduce a pressure experienced by the user as a smaller amount of fluid may be delivered to the handle 104.

With reference to FIG. 6B, if during operation of the pump assembly 112, the user activates the handle valve 116, such as by manipulating a handle control 113, the handle valve 116 will close or obstruct a fluid pathway from the hose 108 to the tip 106. For example, the handle valve 116 may block an internal flow pathway within the handle 104 that may prevent fluid from reaching the tip 106. Alternatively, if in instances the flow pathway to the tip 106 otherwise becomes obstructed (e.g. due to debris), the pressure relief valve assembly 128 may still be activated.

Once the flow to the handle 104 is obstructed, pressure builds inside valve chamber 206 and exerts an upward force on seal 130. Once the fluid pressure overcomes the biasing force of the spring 132, the spring 132 compresses and the pressure relief assembly 128 moves from a closed position to an open position within the valve housing 124. Specifically, the relief valve body 220 moves relative to the valve housing 124 and the seal 130 unseats from the shoulder 265 in the valve housing 124 and the head 222 moves towards the reservoir port 188. As the head 222 moves and the seal 130 disengages, a fluid path (e.g. bypass flow path) is defined or opened around the securing lip 226, neck 224, and head 222, e.g., around the exterior of the relief valve body 220. When the pressure relief assembly 128 moves towards the open position, fluid flows from the valve chamber 206 through the one-way valve 140 to fill the displaced volume. When the pressure relief assembly 128 reaches the open position, the one-way valve 140 closes and traps fluid in the chamber 240, the fitting assembly 122, and the hose 108. The trapped fluid holds the valve in the open position by exerting a force on seal 134 until the flow path to the tip 106 is unobstructed. New fluid introduced into the valve chamber 206, such as due to continued operation of the pumping assembly 112, is then directed into the valve chamber 206 and back out to the reservoir 102 via the flow path defined around the head 222 of the relief valve body 220.

In instances where the pump inlet 186 may be formed with the valve housing 124, the reservoir port 188 may then include fluid flow in two directions during operation of the pump assembly 112. For example, the fluid may be pulled into the pump assembly 112 from the reservoir 102 and may also be pushed back into the reservoir 112 from the pump due the fluid pressure caused by the obstruction by the handle valve 116. It should be noted that the pump assembly 112 can continue to run as normal and the pressure relief valve assembly 128 once transitioned to the open configuration, may not need to move again to allow continued fluid delivery back to the reservoir 102. This allows the handle control 113 to function as a true “stop” rather than a temporary pause without generating substantial amounts of noise due to a cycling of a valve between different positions and/or without high fluid pressure buildup. In some embodiments, the handle control 113 may be configured as a slide switch (rather than a push button, for example) to more easily allow the user to maintain the handle control 113 in the stopped or paused position. However, in other embodiments, the handle control 113 may be differently configured.

### CONCLUSION

Any description of a particular component being part of a particular embodiment, is meant as illustrative only and should not be interpreted as being required to be used with a particular embodiment or requiring other elements as shown in the depicted embodiment.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An oral irrigator comprising:
a handle including a tip;
a reservoir;
a pump assembly fluidly coupled to the reservoir and the tip and configured to pump fluid from the reservoir to the tip; and
a valve assembly that directs fluid from the pump back to the reservoir when a flow path between the tip and the pump assembly is obstructed, wherein the valve assembly is vibrationally isolated from the pump assembly.

2. The oral irrigator of claim 1, wherein the valve assembly is fluidly coupled to the pump assembly via one or more flexible connections.

3. The oral irrigator of claim 1, wherein the valve assembly comprises a valve housing defining a pump connector in fluid communication with an outlet of the pump assembly.

4. The oral irrigator of claim 3, wherein the pump connector is coupled to the outlet of the pump assembly via a hose.

5.-6. (canceled)

7. The oral irrigator of claim 1, further comprising a housing enclosing the pump assembly, wherein the valve assembly is rigidly secured to the housing.

8. The oral irrigator of claim 7, wherein a surface of the valve housing directly engages a surface of the housing.

9. The oral irrigator of claim 7, wherein a fastener extends through a portion of the valve assembly and a portion of the housing to secure the valve assembly to the housing.

10. The oral irrigator of claim 1, wherein the valve assembly further comprises:
a valve body; and
a relief valve assembly at least partially received within the valve body, wherein the relief valve assembly is movable within the valve body between an open position and a closed position.

11. The oral irrigator of claim 10, wherein the relief valve comprises a relief valve body defining a flow bore therein and flow from the pump assembly flows through the flow bore when the relief valve assembly is in the closed position.

12.-15. (canceled)

16. A valve assembly for an oral irrigator comprising:
a valve housing defining a valve chamber, the valve chamber in fluid communication with a pump assembly and a reservoir; and
a relief valve assembly received within the valve housing and movable between a first position and a second position within the valve housing, the relief valve assembly comprising:
a relief valve body having a closed end and an open end;
a seal coupled to the closed end of the relief valve body; and
a one-way valve positioned adjacent to the open end of the relief valve body; wherein
in a first position, the seal engages a sidewall of the valve housing to prevent fluid flow from the valve chamber to the reservoir and the one-way valve opens to allow fluid flow to exit the valve chamber from the open end of the relief valve body; and
in a second position, the one-way valve closes and the seal disengages the sidewall of the valve housing to enable fluid flow from the valve chamber to the reservoir.

17. The valve assembly of claim 16, wherein the open end of the relief valve is in fluid communication with a handle flow path and the one-way valve closes upon a blockage of the handle flow path.

18. The valve assembly of claim 17, wherein the relief valve body comprises one or more valve ports defined therein, wherein in the first position, fluid flows into the valve ports through the open end of the relief valve.

19. The valve assembly of claim 16, wherein in the second position, a bypass flow path is defined between an exterior of the relief valve body and the sidewall of the valve housing.

20. The valve assembly of claim 16, wherein the valve housing is configured to be rigidly mounted to a housing of an oral irrigator.

21. The valve assembly of claim 16, wherein the valve housing comprises a pump connector in fluid communication with the pump assembly and the valve chamber, wherein the pump connector delivers fluid to the valve chamber from the pump assembly.

22. The valve assembly of claim 21, wherein the fluid flow through the pump connector flows in a single direction, from the pump assembly to the valve chamber.

23. (canceled)

24. The valve assembly of claim 16, wherein the relief valve body further defines a valve bore in fluid communication with the valve chamber and the open end of the relief valve body.

25. The valve assembly of claim 24, wherein the valve bore extends partially along a length of the relief valve body.

26. The valve assembly of claim 24, wherein an interior wall of the relief valve body defines a first end of the valve bore and the open end of the relief valve body defines a second end of the valve bore.

27. The valve assembly of claim 16, wherein the valve housing comprises:
a reservoir port configured to fluidly couple to a reservoir; and
a pump connector configured to fluidly couple to a pump assembly.

28. An oral irrigator comprising:
a handle including a tip;
a reservoir;
a pump assembly fluidly coupled to the reservoir and the tip and configured to pump fluid from the reservoir to the tip; and
a valve assembly that directs fluid from the pump back to the reservoir when a flow path between the tip and the pump assembly is obstructed, the valve assembly comprising:
a valve housing defining a valve chamber;
a relief valve assembly movable within the valve chamber between a first position defining a first flow path to the tip and a second position defining a second flow path to the reservoir; and
a pump connector coupled to the valve housing in fluid communication with the pump assembly and the valve chamber, wherein fluid flows in a single direction through the pump connector.

29.-35. (canceled)
